(19) United States
(12) Patent Application Publication
(10) Pub. No.: US 2016/0016520 A1
(43) Pub. Date: Jan. 21, 2016

(54) VEHICULAR INFANT OCCUPANCY INDICATOR SYSTEM

(71) Applicant: Richard W. Meyer, Vallejo, CA (US)

(72) Inventor: Richard W. Meyer, Vallejo, CA (US)

(21) Appl. No.: 14/801,498

(22) Filed: Jul. 16, 2015

Related U.S. Application Data
(60) Provisional application No. 62/025,976, filed on Jul. 17, 2014.

(51) Int. Cl. B60R 13/00; B60N 2/28

(52) U.S. Cl. CPC B60R 13/00; B60N 2/28

(57) ABSTRACT

A baby-on-board indictor system including a placard reminder disposed on or integrated into a fabric seat back or seat bottom of a child car seat, and a placard removably affixed to the placard reminder. When the placard is removed from the car seat for temporary placement, it may be displayed in a vehicle window to alert outsiders that an infant is an occupant in the vehicle. When the infant is removed from the car seat, the placard reminder is readily seen and prompts a user to remove the placard from the vehicle window and replace it over the placard reminder. First responders are usefully informed of the actual presence of a child in a vehicle and not misled as to the presence of a child in the vehicle when a child is not, in fact, an occupant.

### CROSS REFERENCES TO RELATED APPLICATIONS

The present application claims the benefit of the filing date of United States Provisional Patent Application Ser. No. 62/025,976, filed Jul. 17, 2014 (Jul. 17, 2014), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

1. Field of the Invention

The present invention relates most generally to vehicle juvenile product safety devices, and more particularly to a vehicle occupancy indicator, and still more particularly to a vehicular infant occupancy (i.e., “baby-on-board”) indicator system to ensure accurate indications of whether vehicle occupants include an infant.

2. Background Discussion

There is some debate, trivial in most respects, about how the baby-on-board signs were first conceived: some assert it was in response to a horrific accident in Canada in which a baby was left in a vehicle after first responders pulled the infant's unconscious mother from the vehicle, only to later find the lifeless body of the baby still in the car; others characterize that as an urban myth and ascribe the “invention” Michael Lerner, founder of Safety 1^{st}, which began manufacturing the signs in the early 1980s. However it was conceived and for whatever reason, the placard has always had functioned to accomplish two things. First, when displayed in the window of a vehicle, it has served to admonish other drivers to drive safely, as the highways include vehicles occupied by innocent and vulnerable infants. Second, it has served to alert first responders that an infant may be an occupant in a vehicle involved at an accident scene or an emergency situation.

A problem in using baby-on-board placards is that the users (i.e., mothers, fathers, babysitters, other child guardians) are not entirely reliable. On occasion a driver or other responsible adult will leave a placard displayed in a vehicle window when an infant is not, in fact, present as an occupant in the vehicle. Alternatively, a responsible adult may simply fail to display the placard when an infant is, in fact, an occupant. This unreliability has made it impossible for first responders to depend on the indications or lack of indications by these placards.

Despite the activity in this field, particularly in the arena of electronic seat sensors with alerts sent through a cellular phone network, there remains a need for a system to remind and motivate responsible adults to display or remove from display an infant on board indicator placard according to actual occupancy in the vehicle. The present invention meets this need.

### BRIEF SUMMARY OF THE INVENTION

The present invention is system and apparatus for reminding a responsible adult or other guardian to place and remove an infant-on-board (aka, “baby-on-board” or “child inside”) placard in accordance with actual occupancy by an infant.

It is therefore an object of the present invention to provide a simple, yet effective way to remind and encourage those in care of infants in vehicles to place a placard when an infant actually does occupy a vehicle, and to remove the placard when an infant is not a vehicle occupant.

It is another object of the present invention to provide an improved infant occupant indicator system that reduces the likelihood that first responders at an accident scene will fail to appreciate the presence of an infant in an involved vehicle.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is schematic side view in elevation of the most essential elements of the vehicular infant occupancy indicator system of the present invention, showing a first preferred embodiment of an infant car seat and indicator placard prepared for use in a vehicle (partially shown);

FIG. 1B is the same view showing an infant occupying the car seat and the placard removed from the seat and placed on a vehicle window;

FIG. 1C is a perspective view showing the reminder placard disposed on the seat back;

FIG. 1D is an exploded perspective view showing the reminder indications on the seat back, reminding a responsible adult to replace the placard when the infant is removed from the seat and the vehicle;

FIG. 1E is a rear view of the placard showing the “hook” portion of the fastening material;

FIG. 1F is a side view in elevation of the reminder placard;

FIG. 1G is an upper right perspective view of the front side of the reminder placard;

FIG. 2 is a schematic side view in elevation showing a vehicle displaying an exemplary placard as might be used in the present invention;

FIG. 3 is a schematic side view in elevation showing a second preferred embodiment of the present invention, wherein placement of an infant in the car seat activates a hard wired pressure switch and closes a light illumination circuit lighting a child inside placard;

FIG. 4 is the same view showing a third preferred embodiment, this being a wireless system of the kind shown in FIG. 3;

FIG. 5 is a schematic side view in elevation showing yet another, fifth preferred embodiment, in which buckling a snap, puzzle, or latch-type buckle sends an illumination signal to a placard in wireless communication with the buckle transmitter;

FIG. 6A is a front view in elevation showing a simple non-illuminated placard for use with the preferred embodiments of the present invention;

FIG. 6B is the same view showing alternative mounting means for the placard;

FIG. 7A is a front view in elevation of an illuminated placard with permanent mounting means;

FIG. 7B is a rear view in elevation showing a battery powered wired illuminated placard for use with a pressure switch disposed in the seat bottom of an infant car seat;

FIG. 7C is a rear view showing an illuminated placard using 12 vehicle power source; and

FIG. 7D is a rear view showing a battery powered wireless illuminated placard.

### DETAILED DESCRIPTION OF THE INVENTION

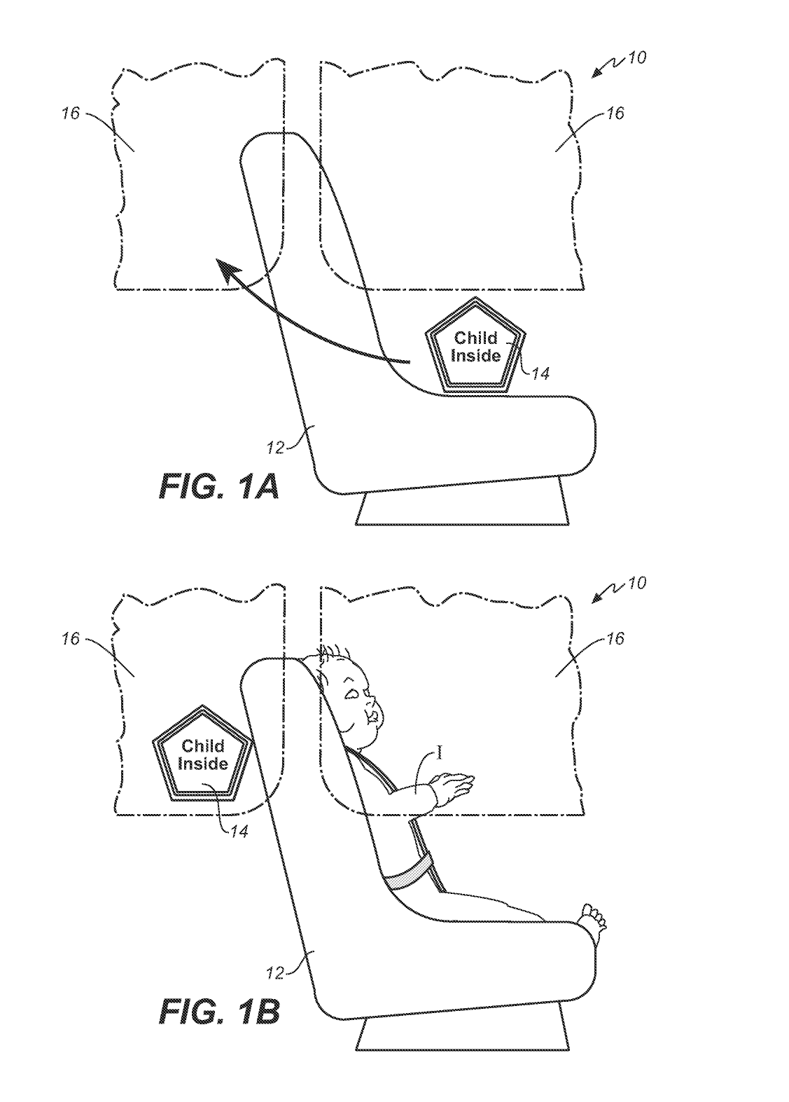

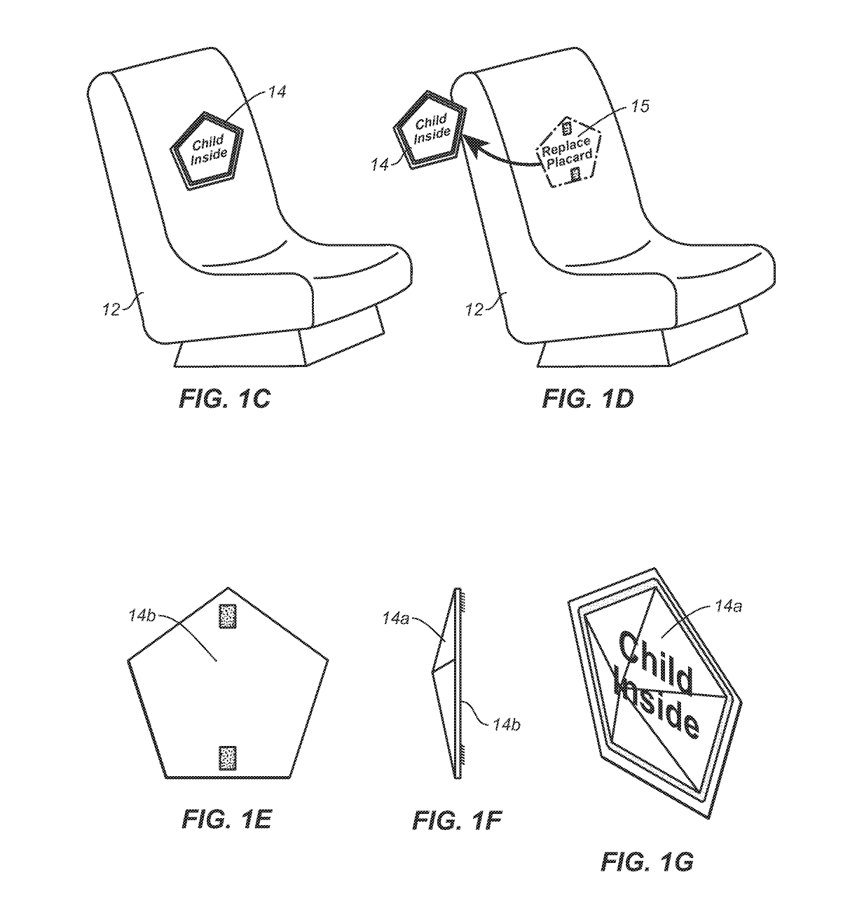

Referring to FIGS. 1 through 7D, wherein like reference numerals refer to like components in the various views, there is illustrated therein a new and improved vehicular infant occupancy indicator system, generally denominated 10 herein.

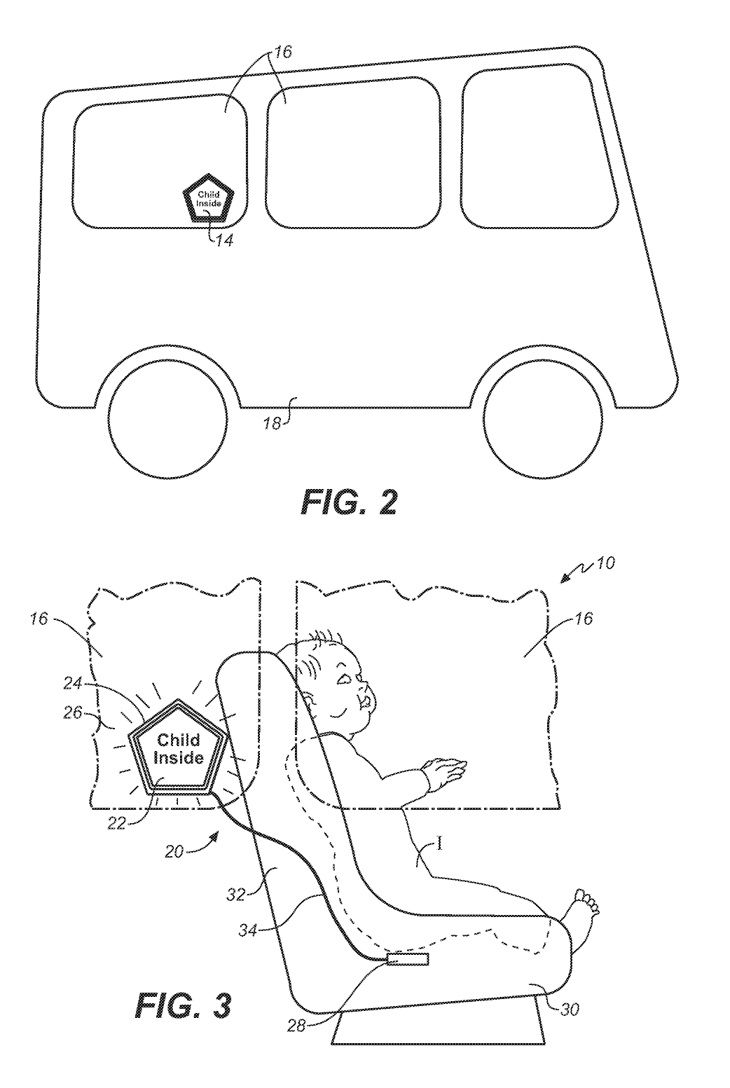

FIGS. 1A through FIG. 2 illustrate a first preferred embodiment of the inventive vehicular infant occupancy indicator system of the present invention, showing in highly schematic form a car seat 12 and placard 14 combination as used in the present invention. This view illustrates the elegance and simplicity of the inventive concept, which is that an indicator placard 14 is disposed on or about the car seat 12 in such a way that an infant I cannot be placed in the seat without the responsible adult noting and removing the placard before placing the infant in the seat. The placard bears some kind of word or phrase comprising a simple combination of words that clearly and unmistakably indicate that an infant or young child is an occupant in the vehicle. It is hoped that such an indication is a sufficient reminder or prompt to the adult to then remove the placard and place it in a vehicle window 16 for display to people outsider the vehicle 18.

The seat preferably includes a large and conspicuous brightly colored soft patch of fabric 15 (the “placard reminder”) on the seat back and/or seat bottom that reminds a driver or other responsible adult when the placard is improperly displayed—as when an infant is not, in fact, in the car seat or, more importantly, in the vehicle. The reminder may include actual verbiage, such as “Replace Sign”, or other such verbiage, or it may comprise other words and/or symbols conveying, in sum and substance, the same thing.

The front side 14a of the placard 14 includes the “baby-on-board” or “infant inside” indication, whereas the back side 14b includes fastener material, preferably the “hook” portion of hook and loop fastener material, complementary to the “loop” portion of the same fastener material disposed on the seat back or seat bottom cushion and comprising the placard reminder. Numerous other means for removably affixing the placard to the seat cover are possible, and thus the use of hook and loop material is a non-limiting preferred embodiment.

FIG. 3 shows an alternative embodiment 20 in which the placard 22 is an illuminated placard with illumination means 24 disposed about the periphery 26 of the placard. A pressure switch 28 (either OEM or retrofit) is positioned in the seat bottom 30 of the infant car seat 32 in wired connection 34 with the illumination means of the placard, such that when an infant is placed in the seat, the circuit is closed and the power source energizes the lights in the illumination means.

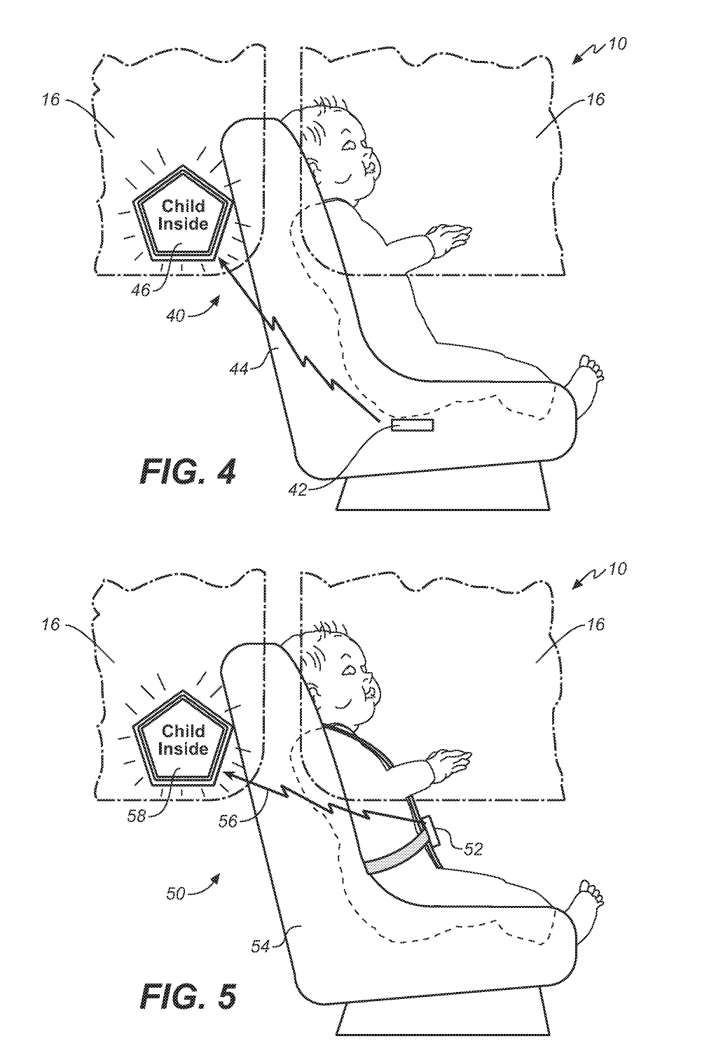

FIG. 4 shows an identical system 40 to that shown in FIG. 3, except that the pressure switch 42 includes a transmitter in wireless RF communication with a receiver in the placard that sends a signal 44 to energize the illumination circuit and illuminate lights (e.g., LEDs) 46 when the pressure switch is activated. When the infant is removed from the seat, the pressure switch sends a signal to the placard receiver to open and de-energize the illumination circuit.

FIG. 5 shows yet another preferred embodiment 50, in this instance including a transmitter placed in the buckle 52 of the infant car seat 54, such that when an infant is buckled into the seat, the transmitter sends a wireless RF signal 56 to a receiver in the placard 58, which in turn energizes the illumination circuit. The circuit is opened and de-energized when the buckle is unbuckled.

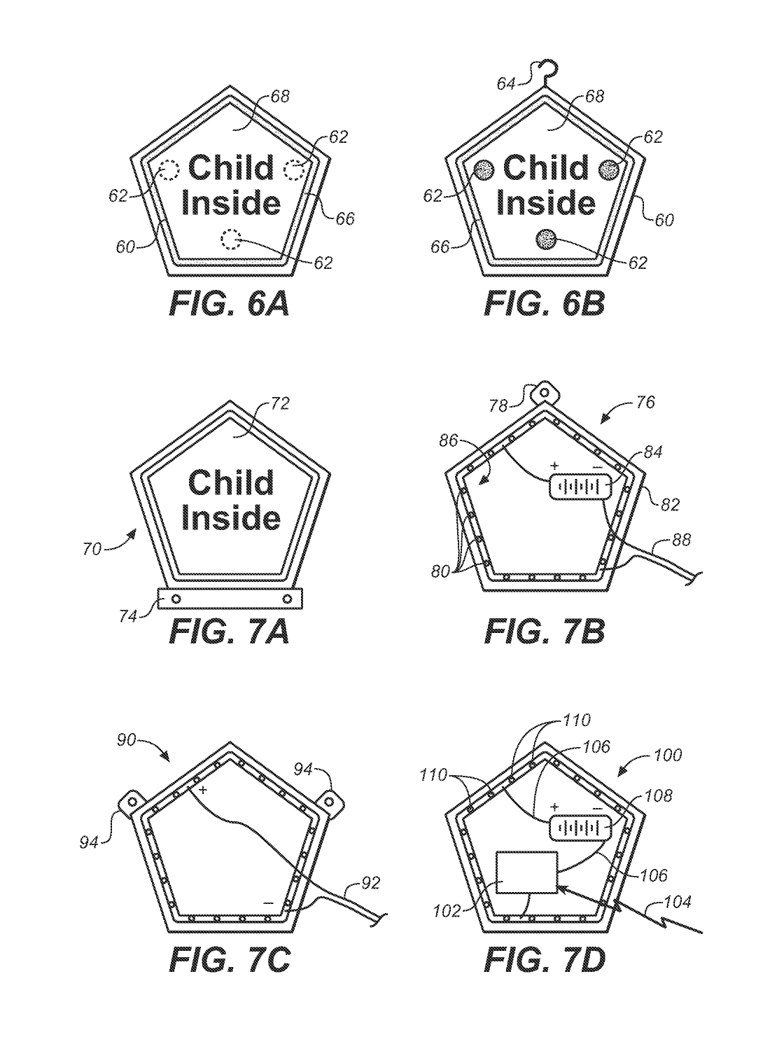

FIGS. 6A and 6B are front views of purely “manual” placards as may be used in the first preferred embodiment of the inventive system. This placard 60 includes any of a number of suitable window mounting means 62, including Velcro, suction cups and hooks 64, and the like. It may also include a reflective perimeter stripe 66 and reflective lettering 68.

FIG. 7A shows a placard 70 having an illuminated (lighted) lens 72 covering the “Child Inside” lettering and front surface of the placard, and a mounting bracket 74 for semi-permanent placement on or proximate a car window, such as on a rear window sill. FIG. 7B is a rear view of a slight variation in a similar placard 76 having hanging apparatus 78 for hanging the placard. This embodiment includes a plurality of LEDs 80 disposed about the periphery 82 of the placard, which are powered by a battery 84 disposed on the rear side 86 of the placard and in wired connection via wire leads 88 to an infant car seat pressure switch or buckle switch.

FIG. 7C shows an alternative LED illuminated placard 90 with a wired connection 92 to the vehicle 12 volt electrical system for circuit power, as well as alternative hanging elements 94.

FIG. 7D shows a placard 100 having a battery powered receiver 102 for receiving an RF signal 104 from an infant car seat pressure switch or buckle switch and accordingly causing the illumination circuit 106 to be energized or de-energized by a battery 108 for lighting a plurality of LEDs or other light devices 110.

Accordingly, it will be evident that the essential aspects of the indictor system reside in the placard and placard reminder elements. The placard reminder elements in a first preferred embodiment are purely visual and correspond to manual operation only, and are thus disposed on or integrated into the surface of the fabric covering the seat back and/or seat bottom. As such, the placard and placard reminder components may be incorporated into the child safety seat at the time of manufacture or sold separately for application onto the seat covering. In the electronic version, the reminder component is an electronic warning or alert system activated by pressure sensors or other electronic devices adapted for sensing the presence of an occupant in the car seat.

It will also be appreciated that the placard is generally planar and is preferably geometrically shaped to signify a meaning corresponding with conventional traffic sign meanings For instance, a pentagonal shape may be preferred because such a shape is employed for school advance warning signs, and such a shape carries with it a meaning evoking images of children. However, other shapes may be employed with the intended effect. For instance, a diamond shape may be employed, inasmuch as this shape is conventionally employed for warning signs. An octagon may also be employed, in that it is the shape used for stop signs, and thus signifies danger so as to make the viewer alert. A rectangle with the longer dimension in the horizontal orientation may also be used, insofar as such shape is typically employed in warning signs.

The preferred embodiments of the present invention enable responsible adults to display a child on board placard only when an infant is actually a vehicle occupant, thereby reducing the incidents in which first responders either fail to appreciate that an infant is in a vehicle or needlessly risk their lives attempting to save an infant not anywhere near the vehicle.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A vehicular infant occupancy indicator system for a child car seat in a vehicle, comprising:
a placard for display in the vehicle window, said placard bearing verbiage indicating that a child is an occupant in the vehicle;
seat mounting structure for removably affixing said placard to a child car seat;
a placard reminder for display on a surface of the car seat, said placard reminder including a visual indication that said placard ought to be removed from display and replaced over the placard reminder; and
window mounting structure for removably displaying said placard in a vehicle window.

2. The infant occupancy system of claim 1, wherein said placard is geometrically shaped in the form of a warning traffic sign.

3. The infant occupancy system of claim 2, wherein said placard is pentagonal.

4. The infant occupancy system of claim 1, wherein the child car seat includes a seat back cushion and said seat placard reminder comprises a fabric patch disposed on the seat back cushion.

5. The infant occupancy system of claim 4, wherein said fabric patch comprises a portion of the seat back fabric.

6. The infant occupancy system of claim 4, wherein said fabric patch is a separate article of fabric disposed on the seat back cushion.

7. The infant occupancy system of claim 1, wherein the child car seat includes a seat bottom cushion and said seat placard reminder comprises a fabric patch disposed on the seat bottom cushion.

8. The infant occupancy system of claim 7, wherein said fabric patch comprises a portion of the seat bottom fabric.

9. The infant occupancy system of claim 4, wherein said fabric patch is a separate article of fabric disposed on the seat bottom cushion.

10. The infant occupancy system of claim 1, wherein said window mounting structure comprises hook and loop fastener material.

11. The infant occupancy system of claim 1, wherein said window mounting structure comprises a hook.

12. The infant occupancy system of claim 1, wherein and placard includes a reflective perimeter stripe.

13. The infant occupant system of claim 1, wherein said placard includes reflective lettering.

14. A baby-on-board indicator, comprising:
a placard bearing an indication that an infant is an occupant of a vehicle, said placard bearing structure for removable affixation to an infant car seat;
a placard reminder disposed on a surface of the infant car seat, said placard reminder sized and shaped similarly to said placard, such that when said placard is removed from the car seat said placard reminder is exposed and visualizable.

15. The baby-on-board indicator of claim 14, wherein said placard reminder bears indicia to remind a user that said placard should be replaced to cover said placard reminder when an infant is removed from the car seat.

16. The baby-on-board indicator of claim 15, wherein said indicia comprises a symbol or words or a combination thereof.

17. The baby-on-board indictor of claim 15, further including seat mounting structure for affixing said placard to the car seat.

18. The baby-on-board indicator of claim 15, further including window mounting structure for removably placing and displaying said placard in a vehicle window.

19. The baby-on-board indictor of claim 18, wherein said window mounting structure comprises hook and loop material.

20. The baby-on-board indicator of claim 15, further including seat mounting structure for removably affixing said placard to a surface of the car seat.
